(19) United States
(12) Patent Application Publication
(10) Pub. No.: US 2026/0192794 A1
(43) Pub. Date: Jul. 9, 2026

(54) VEHICLE COMPATIBLE WITH AUTOMATED VALET PARKING

(71) Applicant: TOYOTA JIDOSHA KABUSHIKI KAISHA, Toyota-shi (JP)

(72) Inventors: Tatsuya SUGANO, Seto=shi (JP); Hidenobu Kinugasa, Nagoya-shi (JP); Takahiro Yamamoto, Toyota-shi (JP)

(73) Assignee: TOYOTA JIDOSHA KABUSHIKI KAISHA, Toyota-shi (JP)

(21) Appl. No.: 19/368,342

(22) Filed: Oct. 24, 2025

(30) Foreign Application Priority Data
Jan. 9, 2025 (JP) 2025-003690

(51) Int. Cl. B60W 30/06

(52) U.S. Cl. CPC B60W 30/06; B60W 2556/10; B60W 2556/45

(57) ABSTRACT

The vehicle control device acquires, from the infrastructure of the automated valet parking, an instruction related to the operation control for the automated valet parking and an instruction related to the stop control or reference information based on the sensing information of the in-vehicle sensor. The vehicle control device sets the operation condition of the stop control for each section of the traveling route based on the instruction or the reference information related to the stop control, operates the vehicle in accordance with the instruction related to the operation control, and operates the stop control in response to the establishment of the operation condition of the stop control.

### CROSS-REFERENCE TO RELATED APPLICATION

This application claims priority to Japanese Patent Application No. 2025-003690 filed on January 9, 2025. The disclosure of the above-identified application, including the specification, drawings, and claims, is incorporated by reference herein in its entirety.

### BACKGROUND

### Technical Field

The present disclosure relates to a vehicle compatible with automated valet parking.

### Description of Related Art

Japanese Unexamined Patent Application Publication No. 2021-84626 (JP 2021-84626 A) discloses a technique in which when an infrastructure that supports automated valet parking receives a parking request from a vehicle, the infrastructure checks whether a sensor mounted on the vehicle operates normally, checks whether required operation required for the automated valet parking is performed by the vehicle, and determines whether the automated valet parking can be performed for the vehicle based on the check results.

### SUMMARY

In the case of an automated valet parking system that relies on sensors provided in vehicles as in the above-described related art, the number of vehicles that can use the automated valet parking is limited. In addition, sensors for emergency braking or the like for collision suppression have different sensitivities among vehicles. Therefore, the sensors may be unnecessarily activated in some vehicles, making it difficult to continue the automated valet parking, or affecting the following vehicles.

On the other hand, there is a system that performs automated valet parking using sensors included in the infrastructure. In such a system, there are fewer constraints on the use of the automated valet parking by vehicles. However, the sensors provided in the infrastructure are not necessarily versatile, as a blind spot may be formed by a vehicle or a structure in the premises, for example.

An aspect of the present disclosure provides a vehicle compatible with automated valet parking, including:

an in-vehicle sensor that performs sensing around the vehicle; and a vehicle control device connected to the in-vehicle sensor. The vehicle control device acquires an instruction related to operation control for the automated valet parking from an infrastructure for the automated valet parking, and acquires an instruction or reference information related to stop control based on information sensed by the in-vehicle sensor from the infrastructure. Then, the vehicle control device sets an activation condition for the stop control for each section of a travel route based on the instruction or the reference information related to the stop control, causes the vehicle to operate according to the instruction related to the operation control, and activates the stop control in response to establishment of the activation condition for the stop control.

According to the present disclosure, it is possible to make the activation condition for the stop control stricter in a section in which it is highly likely that the stop control based on the information sensed by the in-vehicle sensor is unnecessarily activated. Accordingly, it is possible to improve the safety of the automated valet parking by using both the sensor included in the infrastructure and the in-vehicle sensor while suppressing the effect of the unnecessary activation of the stop control.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram illustrating a configuration of an automated valet parking system;

FIG. 2 is a diagram illustrating a setting example of an operation condition of stop control by an in-vehicle sensor;

FIG. 3 is a flowchart illustrating an example of processing performed in an infrastructure during automated valet parking;

FIG. 4 is a flowchart illustrating an exemplary process performed by the vehicle control device during automated valet parking; and

FIG. 5 is a flowchart illustrating another example of processing performed in the infrastructure during automated valet parking.

### DETAILED DESCRIPTION OF EMBODIMENTS

### 1. Configuring an automated valet parking System

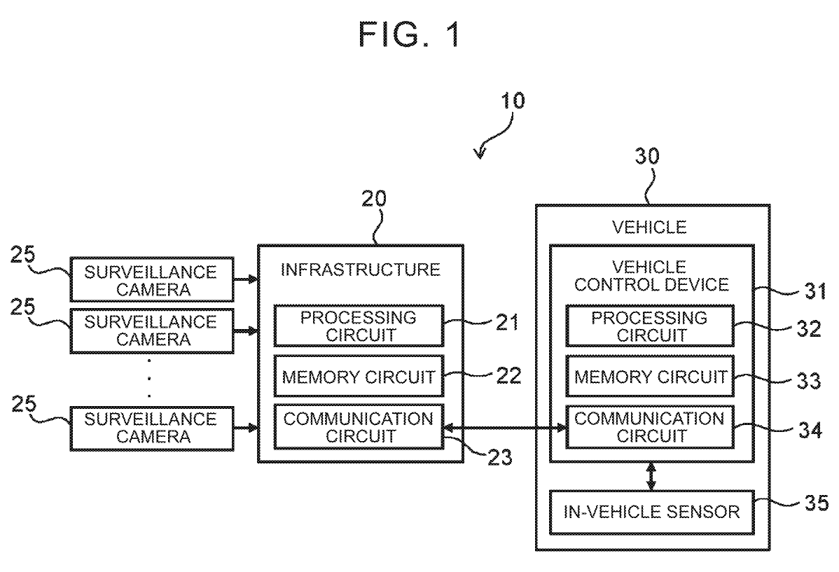

FIG. 1 shows a configuration of an automated valet parking system 10 according to the present embodiment. The automated valet parking system 10 includes an infrastructure 20 that supports automated valet parking, and a vehicle 30 that supports automated valet parking.

Infrastructure 20 is a computer that controls vehicle 30 in a parking lot where automated valet parking system 10 is provided. The infrastructure 20 may be a physical server, a cloud server, or a combination of a physical server and a cloud server. The infrastructure 20 acquires sensing information for automated valet parking from a plurality of infrastructure sensors installed in a parking lot in real time, and performs processing related to automated valet parking based on the sensing information.

A representative example of the infrastructure sensor is a monitoring camera 25 arranged along a road on which the vehicle 30 travels. During automated driving by automated valet parking, the vehicle 30 enters an imaging range of at least one monitoring camera 25. The monitoring camera 25 is disposed at a height such as a ceiling, a wall, a support, and the like, and photographs the vehicle 30 from above. The photographing angle of the monitoring camera 25 may be adjusted so as to photograph the vehicle 30 from directly above, or may be adjusted so as to photograph the vehicle 30 from obliquely forward, obliquely rearward, or obliquely sideways. In addition to the monitoring cameras 25, LiDAR or millimeter-wave radars may be provided as infrastructure sensors.

The infrastructure 20 includes a processing circuit 21, a storage circuit 22, and a communication circuit 23. The processing circuit 21 is a circuit configured to perform processing related to automated valet parking. The sensing information of the infrastructure sensor including the camera image of the monitoring camera 25 is processed by the processing circuit 21. Processing circuit 21 includes one or more processors, such as CPU, FPGA, or ASIC. The storage circuit 22 is a circuit configured to store a program related to automated valet parking and related data thereof. The storage circuit 22 includes one or more primary memories, and may further include one or more secondary storage. The communication circuit 23 is a circuit configured to communicate with the outside. The communication circuit 23 includes a wireless communication module for performing wireless communication and a wired communication module for performing wired communication. The processing circuit 21 is communicably connected to the storage circuit 22 and the communication circuit 23.

The vehicle 30 has a function necessary for automated valet parking including an automated driving function, and is a target vehicle to be subjected to automated valet parking. Automated driving of the vehicle 30 in the parking lot is controlled by cooperation between the infrastructure 20 and the vehicle control device 31 mounted on the vehicle 30. The vehicle 30 may be an autonomous driving vehicle that can autonomously travel outside the parking lot.

The vehicle 30 includes an in-vehicle sensor 35 that senses the surroundings of the vehicle 30. The in-vehicle sensor 35 includes at least one of a camera, a LiDAR, and a millimeter-wave radar. The in-vehicle sensor 35 is communicably connected to the vehicle control device 31. The sensing information obtained by the in-vehicle sensor 35 is processed by the vehicle control device 31.

The vehicle control device 31 includes a processing circuit 32, a storage circuit 33, and a communication circuit 34. The processing circuit 32 is a circuit configured to perform processing related to automated valet parking. Processing circuit 32 may include one or more processors, such as a CPU, FPGA, or ASIC. The storage circuit 33 is a circuit configured to store a program related to automated valet parking and related data thereof. The storage circuit 33 includes one or more primary memories, and may further include one or more secondary storage. The communication circuit 34 is a circuit configured to communicate with the communication circuit 23 of the infrastructure 20. The communication circuit 34 includes a wireless LAN module for performing wireless communication over a wireless LAN. The processing circuit 32 is communicably connected to the storage circuit 33 and the communication circuit 34.

### 2. Function of the vehicle control device

The vehicle control device 31 controls the operation of the vehicle 30 in accordance with a control instruction from the infrastructure 20. The control instruction is an instruction related to operation control of the vehicle 30 for automated valet parking. The motion control includes starting the vehicle 30, accelerating the vehicle 30, decelerating the vehicle 30, stopping the vehicle 30, and steering the vehicle 30. The infrastructure 20 generates a control instruction so that the vehicle 30 can autonomously travel along the travel route based on the sensing information of the infrastructure sensor including the camera image of the monitoring camera 25. Typically, the infrastructure 20 generates, as a control instruction, a waypoint in which data such as target position information, curve information, speed information, and gradient information is defined.

The vehicle control device 31 performs stop control based on the sensing information of the in-vehicle sensor 35 separately from the operation control based on the control instruction from the infrastructure 20. The stop control includes an emergency brake for avoiding collision with an obstacle detected by the in-vehicle sensor 35 or reducing collision damage. The vehicle control device 31 sets an operation condition for activating the stop control at the start of the automated valet parking, and activates the stop control when the operation condition is satisfied during the execution of the automated valet parking.

The vehicle control device 31 acquires reference information related to the stop control from the infrastructure 20 in order to set the operation condition of the stop control. The reference information related to the stop control includes operation history information of the stop control in a predetermined period in the past. The operation history information is information related to unnecessary operation of the stop control in each section in the parking lot, which is acquired from all vehicles traveling in the parking lot in a predetermined period in the past. Whether or not the operation of the stop control is unnecessary can be determined from the operation frequency of each section. For example, if the probability that a collision is likely to occur is uniform across the entire area of the parking lot, when the operation frequency is high in the specific section, it can be determined that the operation of the stop control in the specific section is an unnecessary operation.

On the basis of the operation history information, the vehicle control device 31 sets the operation condition of the stop control for each section of the traveling route of the vehicle 30. The operation condition of the stop control may be that the detection distance obtained from the sensing information of the in-vehicle sensor 35 is equal to or less than the threshold value. In this case, the vehicle control device 31 sets the magnitude of the threshold value for each section of the traveling route. Zeroing the threshold in an interval is substantially equivalent to turning off the stop control in that interval.

The vehicle control device 31 may acquire an instruction related to stop control from the infrastructure 20. In this case, the infrastructure 20 sets the operation condition of the stop control for each section in the parking lot divided in advance or for each section of the traveling route of the vehicle 30 based on the operation history information of the stop control. Then, the infrastructure 20 transmits, as an instruction regarding stop control, an instruction regarding a parameter that defines the set operating condition to the vehicle control device 31. As an instruction regarding the stop control, an instruction regarding an auxiliary parameter used for calculation of a parameter that defines the set operating condition may be transmitted to the vehicle control device 31.

### 3. Example of setting of operating conditions for stop control

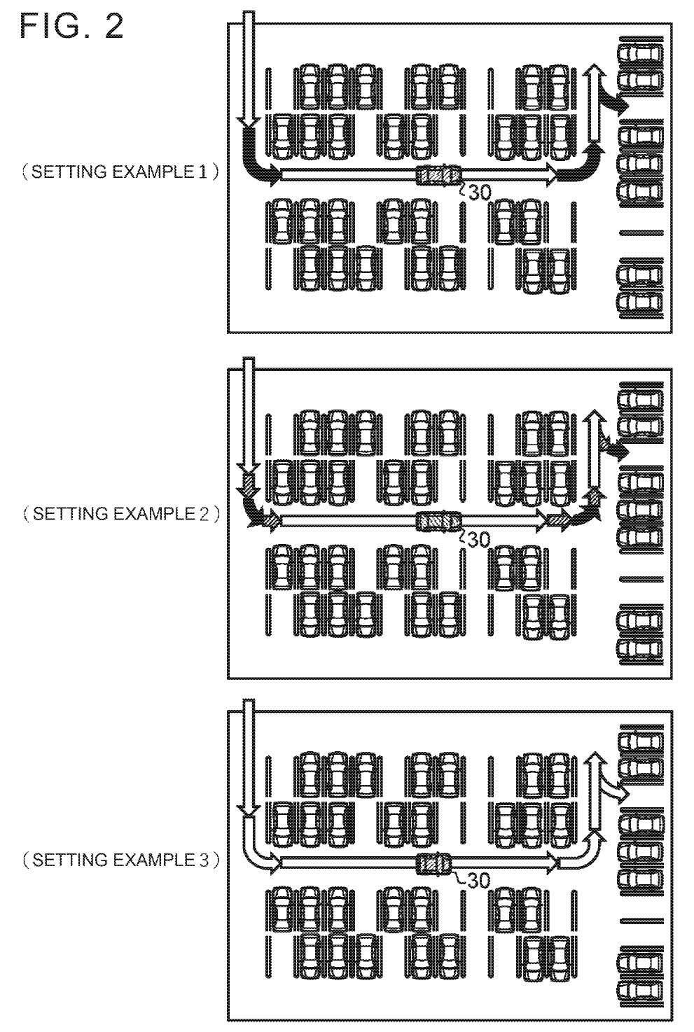

FIG. 2 shows an example of setting the operating condition of the stop control by the in-vehicle sensor 35. FIG. 2 illustrates a state in which the vehicle 30 is autonomously traveling by automated valet parking in a parking lot in which a large number of vehicles are parked, and the traveling route of the vehicle 30 is indicated by a plurality of continuous arrow lines. Each arrow line represents one section of the travel route. The length of each section can be arbitrarily set. In the example illustrated in FIG. 2, the section of the straight portion of the traveling route is set to be long, and the section of the corner portion of the traveling route is set to be short.

In the setting example 1, a section of a black arrow line indicates a section in which the stop control is off, and a section of a white arrow line indicates a section in which the stop control is on. In this example, the stop control is turned on in the straight portion and the stop control is turned off in the corner portion. For example, the frequency of unnecessary operation is high in the corner portion where the distance to the parking vehicle and the side wall is shortened, when the operation history information that the unnecessary operation is hardly generated in the straight portion is obtained, the operation condition of the stop control is set as in the setting example 1. In a period in which the stop control is off, the threshold value for the detection distance is set to zero. In a period in which the stop control is on, the threshold value is set to a value effective for collision avoidance or collision damage mitigation. The threshold value in the section in which the stop control is on may be a fixed value or may be a variable that varies according to the vehicle speed.

In the setting example 2, the operation condition of the stop control is finely set for each section of the traveling route. In the section of the black arrow line, the threshold value for the detection distance is decreased, and the stop control is difficult to operate. In the section of the white arrow line, the threshold value for the detection distance is increased, and the stop control is facilitated to operate. In the hatched section of the arrow line, the threshold value for the detection distance is set to a value intermediate between the threshold value in the section of the black arrow line and the threshold value in the section of the white arrow line, and the ease of operation of the stop control is set to a medium level. By dividing the road in the parking lot into fine meshes and recording the operation history of the stop control for each mesh, it is possible to finely set the operation conditions of the stop control as in the setting example 2.

In the setting example 3, the operation condition of the stop control is set for each vehicle type. As a prerequisite, the infrastructure 20 records the operation history of the unnecessary operation of the stop control for each type of vehicle traveling in the parking lot. For example, a small-sized vehicle that has a margin in a distance from a parked vehicle or a side wall and has a small rotation rate is less likely to perform unnecessary operation of stop control than a large-sized vehicle. Therefore, in the case where the vehicle 30 shown in the setting example 3 is a small vehicle, the threshold value for the detection distance is increased in all sections, and the stop control is facilitated to operate, as indicated by a white arrow line in all sections of the traveling route. Conversely, in the case where the vehicle 30 is a large vehicle, the stop control may be turned off in all sections of the traveling route. Here, the vehicle type is a category based on the specifications of the vehicle, such as length, width, and minimum rotation radius. All vehicles are classified into one of a plurality of categories set in advance.

### 4. Processing performed by the automated valet parking system

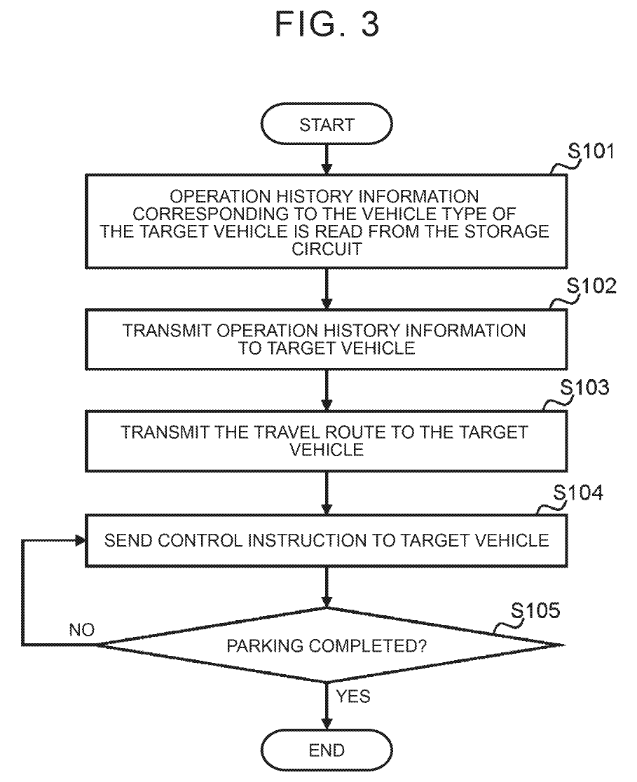

FIG. 3 is a flowchart illustrating an example of a process executed in the infrastructure 20 at the time of automated valet parking. Specifically, the processing illustrated in this flowchart is executed by the processing circuit 21 of the infrastructure 20.

Prior to the execution of the automated valet parking, the infrastructure 20 collects the operation history information of the stop control using the sensing information of the in-vehicle sensor from all the vehicles using the parking lot. The collected operation history information is stored in the storage circuit 22 for each vehicle type.

At the beginning of automated valet parking, the infrastructure 20 performs the process of S101-S103 shown in FIG. 3. In S101, the infrastructure 20 reads the operation history data corresponding to the vehicle type of the vehicle 30 to be subjected to the automated valet parking from the storage circuit 22. In S102, the read operation history is transmitted from the infrastructure 20 to the vehicles 30. In addition, in S103, the infrastructure 20 determines a travel route for automated valet parking, and transmits the determined travel route to the vehicles 30.

After disclosing the automated valet parking, the infrastructure 20 performs the process of S104-S105 shown in FIG. 3. In S104, for example, the infrastructure 20 creates a new control instruction every time the vehicle 30 passes through the waypoint, and transmits the created control instruction to the vehicle 30.

In step 105, infrastructure 20 determines whether parking of vehicle 30 is complete. In the case of automated valet parking performed at the time of delivery, the determination as to whether parking of the vehicle 30 has been completed is replaced with the determination as to whether or not delivery of the vehicle 30 has been completed. S104-S105 process is repeated until S105 determination is Yes. When S105 is determined to be Yes, the process performed by the infrastructure 20 during the automated valet parking ends.

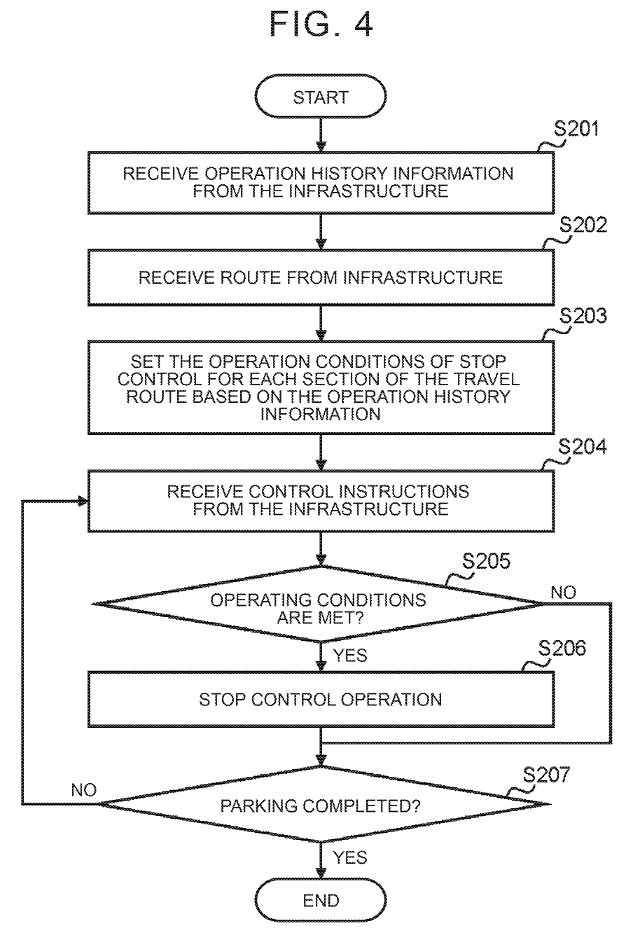

FIG. 4 is a flowchart illustrating an example of processing executed by the vehicle control device 31 of the vehicle 30 that is a target of automated valet parking at the time of automated valet parking. Specifically, the processing illustrated in this flowchart is executed by the processing circuit 32 of the vehicle control device 31.

When the automated valet parking starts, the vehicle control device 31 executes the process of S201-S203 illustrated in FIG. 4. In S201, the vehicle control device 31 receives the operation history data corresponding to the vehicle type of the vehicle 30 from the infrastructure 20. Further, in S202, the vehicle control device 31 receives the travel route of the vehicle 30 from the infrastructure 20. Then, in S203, the vehicle control device 31 sets the operation condition of the stopping control for each section of the traveling route based on the operation history information. The operating condition of the stop control for each set section is temporarily stored in the storage circuit 33. An example of setting the operating conditions is as described with reference to FIG. 2.

After disclosing the automated valet parking, the vehicle control device 31 executes the process of S204-S207 illustrated in FIG. 4. In S204, the vehicle control device 31 receives a control instruction from the infrastructure 20. In step 205, the vehicle control device 31 reads the operation condition of the stop control in the section where the vehicle 30 is currently located from the storage circuit 33, and determines whether the operation condition is satisfied. When the operating condition is satisfied, in step 206, the vehicle control device 31 activates the stop control. Thereafter, the process by the vehicle control device 31 proceeds to S207. On the other hand, when the operating condition is not satisfied, the process by the vehicle control device 31 skips S206 and proceeds to S207.

In S207, the vehicle control device 31 determines whether parking of the vehicle 30 is completed. In the case of automated valet parking performed at the time of delivery, the determination as to whether parking of the vehicle 30 has been completed is replaced with the determination as to whether or not delivery of the vehicle 30 has been completed. S204-S207 process is repeated until S207 determination is Yes. When the determination result of S207 is Yes, the process at the time of the automated valet parking by the vehicle control device 31 ends.

When the above-described processing is executed by the infrastructure 20 and the vehicle control device 31, it is possible to make the operation condition of the stop control stricter in a section in which it is highly likely that the stop control based on the sensing information of the in-vehicle sensor 35 is unnecessarily operated. Accordingly, the safety of the automated valet parking can be improved by using both the infrastructure sensor including the monitoring camera 25 and the in-vehicle sensor 35 while suppressing the influence of the unnecessary operation of the stop control.

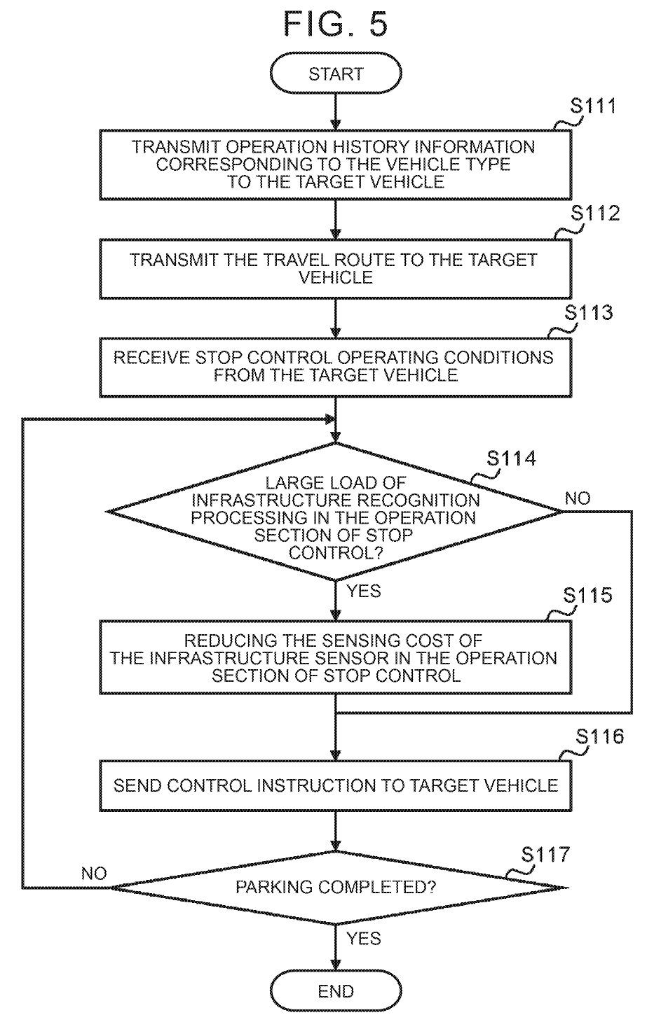

The processing performed by the infrastructure 20 is not limited to the example illustrated in FIG. 3. The processing executed by the vehicle control device 31 is not limited to the example illustrated in FIG. 4. For example, FIG. 5 is a flowchart illustrating another example of a process executed in the infrastructure 20 during automated valet parking. Specifically, the processing illustrated in this flowchart is executed by the processing circuit 21 of the infrastructure 20.

At the beginning of automated valet parking, the infrastructure 20 performs the process of S111-S113 shown in FIG. 5. In S111, the infrastructure 20 transmits, to the vehicle 30, operation history information corresponding to the vehicle type of the vehicle 30 to be subjected to the automated valet parking. In addition, in S112, the infrastructure 20 determines a travel route for automated valet parking, and transmits the determined travel route to the vehicles 30. The vehicle control device 31 of the vehicle 30 sets the operation conditions of the stopping control on the basis of the operation history information and the travel route transmitted by the infrastructure 20 (refer to S203 of FIG. 4). In S113, the infrastructure 20 receives, from the vehicle 30, the operating condition of the stopping control set by the vehicle control device 31.

After disclosing the automated valet parking, the infrastructure 20 performs the process of S114-S117 shown in FIG. 5. In S114, the infrastructure 20 determines whether or not the vehicles 30 are in the operation section of the stop control based on the operation condition of the stop control acquired in S113. Furthermore, the infrastructure 20 determines whether the load of the processing circuit 21 at the time of executing the recognition process using the sensing information of the infrastructure sensor is larger than the reference load.

If the vehicle 30 is in the deactivation control operating section and the load of the recognition process is greater than the reference load, the process by the infrastructure 20 proceeds to S115. In S115, the infrastructure 20 suppresses the sensing cost of the infrastructure sensors when the vehicles 30 are in the deactivation control operating zone. Examples of the sensing cost to be suppressed include the number of infrastructure sensors for acquiring sensing information and resources of the processing circuit 21 used for processing the sensing information.

After S115 is executed, the process by the infrastructure 20 proceeds to S116. When S114 is not satisfied, the infrastructure 20 skips S115 and proceeds to S116. In S116, for example, the infrastructure 20 creates a new control instruction every time the vehicle 30 passes through the waypoint, and transmits the created control instruction to the vehicle 30.

In step 117, infrastructure 20 determines whether parking of vehicle 30 is complete. In the case of automated valet parking performed at the time of delivery, the determination as to whether parking of the vehicle 30 has been completed is replaced with the determination as to whether or not delivery of the vehicle 30 has been completed. S114-S117 process is repeated until S117 determination is Yes. When S117 is determined to be Yes, the process performed by the infrastructure 20 during the automated valet parking ends.

### 5. Other

It should be noted that the above-described embodiments include the following technical ideas related to an automated valet parking system and an automated valet parking method.

### Technical idea 1

A system for providing automated valet parking to a target vehicle, comprising:

A processing circuit is provided,

The processing circuit,

An operation history information of a stop control based on sensing information of an in-vehicle sensor is acquired from a plurality of vehicles traveling in a parking lot where the automated valet parking is performed.

An instruction for controlling an operation of the target vehicle for the automated valet parking is generated based on sensing information of an infrastructure sensor installed in the parking lot.

An operation condition of the stop control based on the sensing information of the in-vehicle sensor of the target vehicle is set for each section of the travel route of the target vehicle based on the operation history information.

The object vehicle is operated according to the instruction related to the operation control,

In response to the establishment of the operation condition of the stop control, the stop control is operated in the target vehicle

automated valet parking System, characterized in that.

### Technical idea 2

In the automated valet parking system described in the technical idea 1, The processing circuit is configured to increase or decrease a sensing cost of the infrastructure sensor for the target vehicle for each section of the travel route based on an operation condition of the stop control for each section of the travel route automated valet parking System, characterized in that.

### Technical idea 3

A method wherein a computer provides automated valet parking to a target vehicle, the method comprising:

Acquiring the operation history information of the stop control based on the sensing information of the in-vehicle sensor from a plurality of vehicles traveling in the parking lot where the automated valet parking is performed,

Generating instructions for controlling operation of the target vehicle for the automated valet parking based on sensing information of an infrastructure sensor installed in the parking lot; An operation condition of the stop control based on the sensing information of the in-vehicle sensor of the target vehicle is set for each section of the travel route of the target vehicle based on the operation history information.

Operating the target vehicle in accordance with the instruction related to the operation control,

In response to the establishment of the operation condition of the stop control, the stop control is operated in the target vehicle

An automated valet parking method, characterized in that.

What is claimed is:

1. A vehicle compatible with automated valet parking, comprising:
an in-vehicle sensor that performs sensing around the vehicle; and
a vehicle control device connected to the in-vehicle sensor, wherein the vehicle control device is configured to:
acquire an instruction related to operation control for the automated valet parking from an infrastructure for the automated valet parking;
acquire an instruction or reference information related to stop control based on information sensed by the in-vehicle sensor from the infrastructure;
set an activation condition for the stop control for each section of a travel route based on the instruction or the reference information related to the stop control;
cause the vehicle to operate according to the instruction related to the operation control; and
activate the stop control in response to establishment of the activation condition for the stop control.

2. The vehicle according to claim 1, wherein:
the reference information related to the stop control is activation history information on the stop control based on the information sensed by the in-vehicle sensor acquired from a plurality of vehicles having traveled in a parking lot in which the automated valet parking is performed; and
the vehicle control device is configured to set the activation condition for the stop control for the section of the travel route based on the activation history information on the stop control.

3. The vehicle according to claim 1, wherein:
the instruction related to the stop control is an instruction related to the activation condition for the stop control for each section in a parking lot in which the automated valet parking is performed or for the section of the travel route; and
the vehicle control device is configured to set the activation condition for the stop control for the section of the travel route according to the instruction related to the activation condition for the stop control.

4. The vehicle according to claim 1, wherein the vehicle control device is configured to set a detection distance obtained from the information sensed by the in-vehicle sensor being equal to or less than a threshold value as the activation condition for the stop control, and to set a magnitude of the threshold value for the section of the travel route.

5. The vehicle according to claim 1, wherein setting of the activation condition for the stop control includes turning off the stop control.

6. The vehicle according to claim 1, wherein the vehicle control device is configured to acquire, from the infrastructure, an instruction or reference information related to the stop control matching a vehicle type of the vehicle.
